(19) United States
(12) Patent Application Publication
(10) Pub. No.: US 2023/0350383 A1
(43) Pub. Date: Nov. 2, 2023

(54) Additively Manufacturing Molds with Localized Gas Permeability

(71) Applicant: California Institute of Technology, Pasadena, CA (US)

(72) Inventor: Scott N. Roberts, Altadena, CA (US)

(73) Assignee: California Institute of Technology, Pasadena, CA (US)

(21) Appl. No.: 18/311,113

(22) Filed: May 2, 2023

Related U.S. Application Data
(60) Provisional application No. 63/337,250, filed on May 2, 2022.

(51) Int. Cl. G05B 19/4099

(52) U.S. Cl. CPC G05B 19/4099; G05B 2219/49023; G05B 2219/45244

(57) ABSTRACT

A device may include a mold body defining a mold cavity. A device may include at least one porosity channel in fluid communication with the mold cavity; and wherein the at least one porosity channel has a sufficiently high porosity to vent entrapped gases from the mold cavity during the manufacture of an output part.

### CROSS-REFERENCE TO RELATED APPLICATION

The current application claims priority to U.S. Provisional Patent Application No. 63/337,250 filed May 2, 2022, the disclosure of which is incorporated herein by reference in its entirety.

### GOVERNMENT SUPPORT CLAUSE

This invention was made with government support under Grant No. 80NMO0018D0004 awarded by NASA (JPL). The government has certain rights in the invention.

### FIELD OF THE INVENTION

The present invention is generally related to additive manufacturing. More particularly it is directed to additive manufacturing applied to mold manufacturing.

### BACKGROUND

Prior methods for additively manufactured molds have not yet been able to replicate the benefits of porous metal molds.

Additive manufacturing techniques have been applied for designing and fabricating injection molds. While the process itself is more expensive than legacy methods. Additive manufacturing of injection molds can enable significant increases in the design of a mold's complexity previously unachievable with traditional subtractive manufacturing. For instance, additive manufacturing techniques have been used to make custom additive manufactured molds with custom designed conformal cooling.

Some additively manufactured molds can have conformal channels featuring non-circular cross-sections (increase surface area closest to the hot area}, maintaining a constant distance from the cooling surface (uniform cooling decreases part distortion), and/or complementary modeling demonstrating how it has improved performance. Additionally, some additive manufactured molds can include light weighted parts. Light weighted parts can include internal voids, internal voids can not only save printing time and material (decreasing cost), but also can make the molds lighter and easier to handle. Software, such as nTopology, can take known thermal and structural loads to improve light weighting, improving the cost, time, weight, and lead-time savings possible with additive manufacturing.

In some typical cases, molds are can be made out of steel, copper, or brass billets with high porosity, fabricated by traditional powder metallurgy techniques to make metal foams. Molds can be manufactured by machining a porous billet into the desired mold. However, this machining operation typically closes off the surface pores, and the final processing typically needs to be performed using an electrical discharge machining (EDM), an expensive and time-consuming process, to reopen the surface pores. Other negatives include: Porosity of the mold is only set as a billet and cannot be locally controlled. Manufacturers offer porosities from 5-25% and pore sizes 3 μm and larger. Using these legacy methods, only alloys which are easily sinterable or have a viscous enough melt to entrap bubbles can be formed into gas permeable billets. This can eliminate the use of some corrosion resistant alloys desirable for chlorinated polymers (e.g., PVC) or high temperature die casting. Furthermore, these molds based on machining porous billets can be expensive to manufacture. Both the pre-formed billets and EDM operations are significantly more expensive than traditional CNC machining of mold making steel. Machined porous molds from porous billets cannot be combined with traditional pumped cooling for taking heat of the mold, as any liquid flowed would simply seep through the pores.

### SUMMARY OF THE INVENTION

In an embodiment, the techniques relate to an additively manufactured mold, the additively manufactured mold including: a mold body defining a mold cavity; at least one porosity channel in fluid communication with the mold cavity; and wherein the at least one porosity channel has a sufficiently high porosity to vent entrapped gases from the mold cavity during the manufacture of an output part.

In another embodiment, the at least one porosity channel extends from the mold cavity to a channel outlet.

In yet another embodiment, the mold body and the at least one porosity channel form a single additively manufactured part.

In still another embodiment, the at least one porosity channel is a region of material with a sufficiently high porosity along a length to vent entrapped gases from the mold cavity to a channel outlet.

In another further embodiment, the at least one porosity channel has a first porosity and the mold body has a region with a second porosity, the first porosity different from the second porosity.

In another embodiment again, the at least one porosity channel has a first porosity and the mold body has a region that is fully dense.

In another additional embodiment, the mold body includes a thermal controlling element disposed within the mold body.

In still yet another embodiment, the mold body includes a thermal controlling element disposed within the mold body, and the thermal controlling element is a thermal controlling element selected from a list, the list consisting of pumped fluid loops, integrated heat pipes, vapor chambers, and oscillating heat pipes.

In yet another further embodiment, a thin layer of high porosity material can be disposed between the cavity and a thermal controlling element.

In yet another embodiment again, a thermal controlling element includes internal conformal thermal controlling channels that conform to the mold cavity.

In yet another additional embodiment, the mold body includes a light weighted portion.

In still another further embodiment, the mold is configured for use in a manufacturing process, the manufacturing process selected from a list consisting of injection molding, blow molding, extrusion, vacuum casting, vacuum forming, thermoforming, compression molding, rotational molding, hydroforming, and die casting.

In still another embodiment again, the at least one porosity channel has a first porosity in a first portion adjacent to the mold cavity, and a second porosity in a second portion adjacent to a channel outlet, and wherein the second porosity is greater than the first porosity.

In still another additional embodiment, the at least one porosity channel includes a first porosity channel and a second porosity channel, and wherein the first and second porosity channel meet of form a third porosity channel such that the third porosity channel is in fluid communication with the first porosity channel, the second porosity channel, and an outlet.

In another further embodiment again, the additively manufactured mold is made of a material selected from a list consisting of aluminum alloys, steels, Inconel alloys, other super alloys, titanium alloys, and refractory alloys.

In an embodiment, the techniques relate to a process for additively manufacturing a mold, the process including: receiving instructions for a mold, the mold including: a mold body defining a mold cavity; at least one porosity channel in fluid communication with the mold cavity; and wherein the at least one porosity channel has a sufficiently high porosity to vent entrapped gases from the mold cavity during the manufacture of an output part; depositing material based on the instructions; and modulating a set of energy input device laser configuration parameters based on the instructions such that the porosity of the mold varies locally according to the instructions.

In another embodiment, the instructions are configured to be used by a laser powder bed fusion system to control a set of laser settings during an additive manufacturing process performed to generate the mold.

In yet another embodiment, the process further including manufacturing the mold.

In still another embodiment, the set of laser configuration parameters are selected from a list, the list consisting of laser power, scan speed, hatch spacing, layer thickness, hatch geometry, spot size, laser spot geometry, bed temperature, and beam offset.

In another further embodiment, the material is deposited using a powder bed fusion system.

In another embodiment again, the porosity channel extends from the mold cavity to a channel outlet.

In another additional embodiment, the mold body and the at least one porosity channel form a single additively manufactured part.

In yet still another embodiment, the at least one porosity channel is a region of material with a sufficiently high porosity along a length to vent entrapped gases from the mold cavity to a channel outlet.

In yet another embodiment again, the at least one porosity channel has a first porosity and the mold body has a region with a second porosity, the first porosity different from the second porosity.

In yet another further embodiment, the at least one porosity channel has a first porosity and the mold body has a region that is fully dense.

In yet another additional embodiment, the mold body includes at least one thermal controlling element disposed within the mold body.

In still another embodiment again, a thermal controlling element is a thermal controlling element selected from a list, the list consisting of pumped fluid loops, integrated heat pipes, vapor chambers, and oscillating heat pipes.

In still another further embodiment a thin layer of high porosity material can be disposed between the cavity and a thermal controlling element.

In still another additional embodiment, a thermal control element includes internal conformal channels that conform to the mold cavity.

In a yet still further embodiment, the mold body includes a light weighted portion.

In a still further additional embodiment, the mold is configured for use in a manufacturing process, the manufacturing process selected from a list consisting of injection molding, blow molding, extrusion, vacuum casting, vacuum forming, thermoforming, compression molding, rotational molding, hydroforming, and die casting.

In another still yet further embodiment, the at least one porosity channel has a first porosity in a first portion adjacent to the mold cavity, and a second porosity in a second portion adjacent to a channel outlet, and wherein the second porosity is greater than the first porosity.

In another still yet further embodiment again, the at least one porosity channel includes a first porosity channel and a second porosity channel, and wherein the first and second porosity channel meet of form a third porosity channel such that the third porosity channel is in fluid communication with the first porosity channel, the second porosity channel, and an outlet.

In another further additional embodiment, the energy input device is selected from a list consisting of a laser and an electron beam device.

In another further additional embodiment again, the mold is made of a material selected from a list consisting of aluminum alloys, steels, Inconel alloys, other super alloys, titanium alloys, and refractory alloys.

In an embodiment, the techniques relate to a process for manufacturing an output part with an additively manufactured mold, the process including: obtaining a mold, the mold including: a mold body defining a mold cavity; at least one porosity channels in fluid communication with the mold cavity; and wherein the at least one porosity channels have a sufficiently high porosity to vent entrapped gases from the mold cavity during the manufacture of an output part; generating an output part using the mold; venting entrapped gasses through a first porosity channel of the at least one porosity channels; and applying a back pressure onto the output part through a second porosity channel of the at least one porosity channels.

In another embodiment, the back pressure ejects the output part.

In a further embodiment, the porosity channel extends from the mold cavity to a channel outlet.

In still another embodiment, the mold body and the at least one porosity channel form a single additively manufactured part.

In a still further embodiment, the at least one porosity channel is a region of material with a sufficiently high porosity along a length to vent entrapped gases from the mold cavity to a channel outlet.

In a yet further embodiment, the at least one porosity channel has a first porosity and the mold body has a region with a second porosity, the first porosity different from the second porosity.

In yet another embodiment, the at least one porosity channel has a first porosity and the mold body has a region that is fully dense.

In still yet another embodiment, the mold body includes a thermal control element disposed within the mold body.

In a still yet further embodiment, a thermal control element is a thermal control element selected from a list, the list consisting of pumped fluid loops, integrated heat pipes, vapor chambers, and oscillating heat pipes.

In still yet another embodiment again, a thin layer of high porosity material can be disposed between the cavity and a thermal controlling element.

In a still yet further embodiment again, a thermal controlling element includes internal conformal thermal control channels that conform to the mold cavity.

In another further embodiment, the mold body includes a light weighted portion.

In yet another further embodiment, the mold is configured for use in a manufacturing process, the manufacturing process selected from a list consisting of injection molding, blow molding, extrusion, vacuum casting, vacuum forming, thermoforming, compression molding, rotational molding, hydroforming, and die casting.

In another further embodiment again, the at least one porosity channel has a first porosity in a first portion adjacent to the mold cavity, and a second porosity in a second portion adjacent to a channel outlet, and wherein the second porosity is greater than the first porosity.

In still yet another embodiment again, the at least one porosity channel includes a first porosity channel and a second porosity channel, and wherein the first and second porosity channel meet of form a third porosity channel such that the third porosity channel is in fluid communication with the first porosity channel, the second porosity channel, and an outlet.

### BRIEF DESCRIPTION OF THE DRAWINGS

The description and claims will be more fully understood with reference to the following figures and data graphs, which are presented as exemplary embodiments of the invention and should not be construed as a complete recitation of the scope of the invention.

FIG. 1 conceptually illustrates an example mold with varying local porosity.

FIG. 2 conceptually illustrates an example mold with varying local porosity and internal thermal controlling channels.

FIG. 3 conceptually illustrates an example of an additively manufactured object with fully dense regions and high porosity regions.

FIG. 4 conceptually illustrates an example process for additively manufacturing an object (e.g., a mold).

FIG. 5 conceptually illustrates an example process for using locally porous molds to manufacture output parts.

FIG. 6 conceptually illustrates a first example mold with locally varying porosity.

FIG. 7 conceptually illustrates a second example of a high porosity mold.

FIG. 8 conceptually illustrates a third example of a high porosity mold.

FIG. 9 conceptually illustrates an example mold with porous regions along mold mating surfaces.

FIG. 10 conceptually illustrates an example mold with internal thermal control channels and externally connected thermal control channels.

### DETAILED DESCRIPTION

In accordance with various embodiments of the invention, molds can be additively manufactured with varying porosity. Porous metal molds can provide a variety of benefits. Porous metal molds can be configured to minimize/eliminate flow & knit lines, provide better cosmetic finish, improve mechanical properties of the mold (e.g., heat transfer rates, loading capabilities), reduce post-finishing operations to create a matte finish or remove knit lines, reduce shrinkage, and/or can enhance mold filling by using suction through the porous mold to improve material mating (e.g., to the mold).

Several embodiments offer a method of fabricating molds for metallic glasses. Some embodiments can include molds for casting metallic glass (e.g., metallic glass spheres which can be suitable for use as high-performance ball bearings). Such metallic glass can be difficult or impossible to be cast traditionally due to entrapped gases. However, several embodiments described herein can be capable of manufacturing metallic glass, and/or metallic glass spheres.

In several embodiments, a process can include releasing a part from a mold by applying gas pressure through pores in the mold.

Many embodiments of additive manufactured porous molds can create a matte finish without expensive post-processing steps, can increase venting area and thereby decrease cycle time, can decrease back pressure in mold from trapped gasses thereby decreasing cycle time. Additively manufacturing porous molds can simplify webbed, ribbed, and/or other thin features since the features do not need individual vents in additively manufactured porous molds.

In accordance with many embodiments, gas from the mold space, can be pushed into and/or through the mold itself. In accordance with numerous embodiments of the invention, an additive manufacturing can allow fabrication of molds with local porosity control (e.g., locally varying porosity), solid thermal controlling channels, light weighting, and/or other structures all in a single part. This is impossible in legacy systems. Machining of high porosity billets fail to provide locally controlled porosity, thermal controlling channels. Legacy additive manufacturing methods fail to provide locally controlled porosity. In several embodiments, methods, and systems, thermal control can include cooling and/or heating systems.

Various embodiments of the invention include a method for locally controlling the porosity of additively manufactured metal parts. This allows the mold to be solid where desired (e.g., solid parts for structural support, solid outer shell, solid fluid lines) and/or gas permeable where desired (e.g., gas permeable mold surfaces, gas permeable mold surfaces near thin features, gas permeable mold surfaces near parting lines). Gas permeability of mold surfaces can be controlled via local porosity control in an additively manufactured mold.

Local porosity control in additively manufactured alloys can be performed through control of the laser beam. In several embodiments control of the laser in an additive manufacturing process can be sufficient to control porosity in a manufactured part. Methods for controlling porosity of an additively manufactured part can include controlling machine parameters. Laser configuration parameters can include laser power, scan speed, hatch spacing, layer thickness, hatch geometry, spot size, laser spot geometry, bed temperature, beam offset, and/or other parameters. In various embodiments, machine parameters can be modulated (e.g., throughout the course of an additive manufacturing process) to attain a desired porosity. The machine parameters can be modulated to locally control the porosity of the part.

In accordance with several embodiments of the invention, additively manufactured molds can include high porosity channels in the structure. High porosity channels can allow gas to flow along predetermined paths. This has similarities to porous ejection pins, except the high porosity channel is fully integrated into the mold and the high porosity channels can have conformable geometries and variable permeabilities (e.g., variable porosities). In some embodiments, a tree-like structure can be manufactured where the smaller branches have smaller pores and permeabilities to tightly control gas flow, while further down the branch permeability increases to enable larger amounts of gas flow.

In some embodiments, after molding, pressure can be applied through the gas permeable regions, simplifying and speeding ejection from the mold. By controlling where the gas can flow in/out by creating fully solid regions, this method is enhanced significantly in a mold with locally varying porosity as compared with traditional porous molds.

To embed single- and/or two-phase thermal management solutions (e.g., pumped fluid loops, integrated heat pipes, thermo syphon heat pipes, constant conductance heat pipes, variable conductance heat pipes, loop heat pipes, vapor chambers, oscillating heat pipes, etc.) inside of the porous structure, various areas can include have local regions which touch the surface of the mold for enhanced thermal controlling, and/or have a thin layer of gas-permeable mold on top, thereby greatly increasing the thermal controlling capability of the mold's surface. Liquid CO2 can, in several embodiments, be injected into the mold and controlling liquid/vapor flow better than in traditional porous molds.

Additive manufacturing with porosity control can be used with many alloys to create molds with porous structures. Molds with porous structures can be made of aluminum alloys, steels, Inconel alloys, other super alloys, titanium alloys, refractory alloys, and/or other metals and/or other alloys. Aluminum can be useful for low temperature molds, lower cost molds, and higher thermal conductivity among other reasons. Steel can be useful for traditional high cycle applications among other reasons. Inconel and other superalloys can be useful for corrosive materials and/or high temperature applications among other reasons. Titanium can be useful for being lightweight, high strength, and for material compatibility and other reasons.

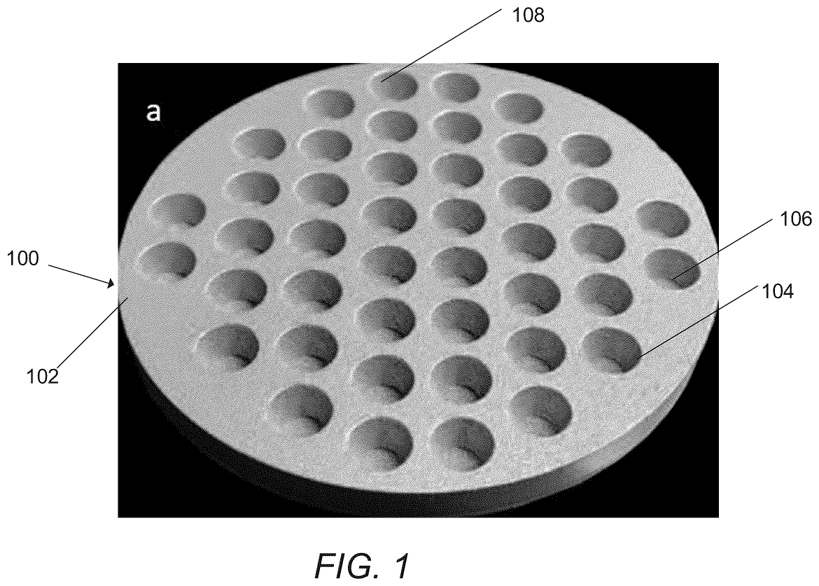

Turning now to the figures. In many embodiments, additive manufacturing can be used to manufacture molds with locally varying porosity. Areas of porous, in accordance with several embodiments of the invention can include local pores with sizes ranging from 50 nm through 50 μm. In porous areas (e.g., regions), porosity can be between around 10% to 60% porosity. Several embodiments can include porosity that is interconnected and/or percolating (e.g., porosity allowing the transport of gas). An example mold with varying local porosity is conceptually illustrated in FIG. 1. A mold 100 can have a front face 102. Many pits 104 can be disposed on the front face 102. Each pit 104 can have a region of high porosity on the bottom 106 and through to the back wall of the mold 100. The high porosity regions can vent gases from the pits 104. In this way, the mold 100 does not include vents other than the high porosity regions for removing entrapped gases. The side walls 108 of the pits can be fully solid. This can be beneficial to enhance heat transfer.

While specific processes, apparatuses and/or systems for a mold with varying local porosity are described above, any of a variety of processes and/or systems can be utilized as a mold with varying local porosity as appropriate to the requirements of specific applications. In certain embodiments, steps and/or components may be performed and/or configured in any order, sequence, and/or configuration not limited to the order, sequence and/or configuration shown and described. In a number of embodiments, some of the above steps may be executed or performed substantially simultaneously where appropriate or in parallel to reduce latency and processing times. In some embodiments, one or more of the above steps and/or components can be rearranged or omitted. Although the above embodiments of the invention are described in reference a mold with varying local porosity, the techniques disclosed herein may be used in any type of additively manufactured gas venting system and/or other object with porous regions. The techniques disclosed herein may be used within any of the additively manufactured molds, high porosity molds, and/or process therefore as described herein.

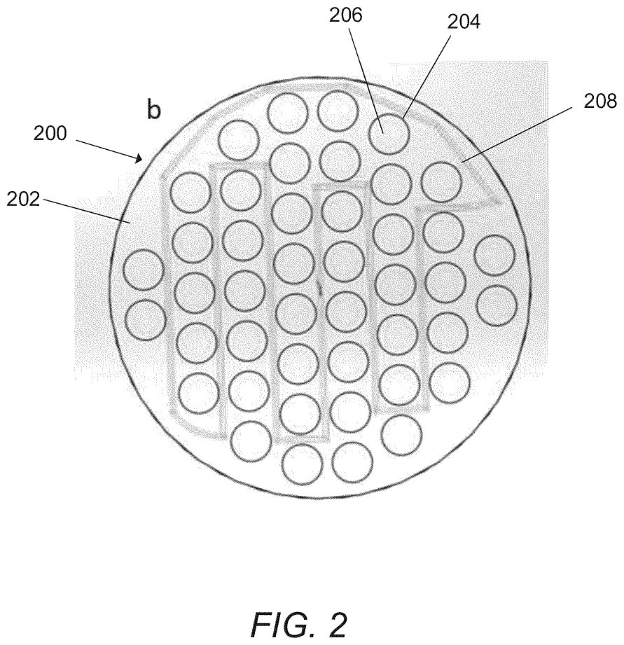

In many embodiments, additively manufacturing can be used to manufacture molds with locally varying porosity and internal thermal controlling channels. An example mold with varying local porosity and internal thermal controlling channels is conceptually illustrated in FIG. 2. A mold 200 can have a front face 202. Many pits 204 can be disposed on the front face 202. Each pit 204 can have a region of high porosity on the bottom 206 and through to the back wall of the mold 200. An internal thermal controlling channel 208 can be disposed internally to the mold and between the pits 204. Internal thermal controlling channels can be conformal thermal controlling channels. The material surrounding the thermal controlling channel 208 can be fully dense.

In many embodiments, an additive manufacturing method can create molds for various injection, blow, extrusion, die casting, and/or other sorts of molding. In particular, several embodiments, allows for a combination of traditional solid mold portions, air-permeable mold portion, and portions with geometry (e.g., internal geometry, thermal controlling channel geometry) suitable (e.g., impossible by conventional means) for manufacture by additively manufactured molds. The methods described herein of enabling hybrid molds with controllable gas permeability is a method, in several embodiments, to create complex porous structures. In many embodiments, no post-finishing is required for the porous surfaces, saving significantly over traditionally EDM cleaned surfaces.

Pore size, permeability, and porosity % can each be locally controlled in accordance with embodiments of the invention. This can enable configuring an additively manufactured mold for a high gas flow rate through some regions and lower gas flow rate through others. Structures can be optimized via software simulations. Locally solid surfaces in molds can be useful for enhanced thermal conduction and/or varying surface finishes. In several embodiments, additively manufactured molds with locally varying porosity can have integrated solid supports.

In some process, after molding, pressure can be applied through the gas permeable regions of an additively manufactured mold with locally varying porosity, thereby simplifying and speeding ejection from the mold. Since the configuration of the mold can include locally varying porosity, control of where the gas can flow in/out by use of regions of varying porosity (e.g., including high porosity region and fully dense regions).

In accordance with several embodiments, an additively manufactured mold with locally varying porosity can include embedded single- or two-phase thermal management solutions (e.g., pumped fluid loops, integrated heat pipes, vapor chambers, oscillating heat pipes, injection of liquid CO2 into the mold, etc.) inside of the porous structure. Thermal management solutions can have local regions which touch the surface of the mold for enhanced thermal controlling, or can have a thin layer of gas-permeable mold on top, to greatly increase the thermal controlling capability of the mold's surface.

In many embodiments, a porous region in a mold can reduce injection and back pressures due to entrapped gas. This can simplify mold design and can enable the elimination of the entire hot runner manifold typically required.

In accordance with several embodiments, the methods described herein can be used in any application in which entrapped gases can cause issues with total replication of a surface. It may be of particular use in hydroforming, deep drawing, and/or other manufacturing processes.

While specific processes, apparatuses and/or systems for a mold with varying local porosity and internal thermal controlling channels are described above, any of a variety of processes and/or systems can be utilized as a mold with varying local porosity and internal thermal controlling channels as appropriate to the requirements of specific applications. In certain embodiments, steps and/or components may be performed and/or configured in any order, sequence, and/or configuration not limited to the order, sequence and/or configuration shown and described. In a number of embodiments, some of the above steps may be executed or performed substantially simultaneously where appropriate or in parallel to reduce latency and processing times. In some embodiments, one or more of the above steps and/or components can be rearranged or omitted. Although the above embodiments of the invention are described in reference to a mold with varying local porosity and internal thermal controlling channels, the techniques disclosed herein may be used in any type of additively manufactured gas venting system and/or other object with porous regions. The techniques disclosed herein may be used within any of the additively manufactured molds, high porosity molds, and/or process therefore as described herein.

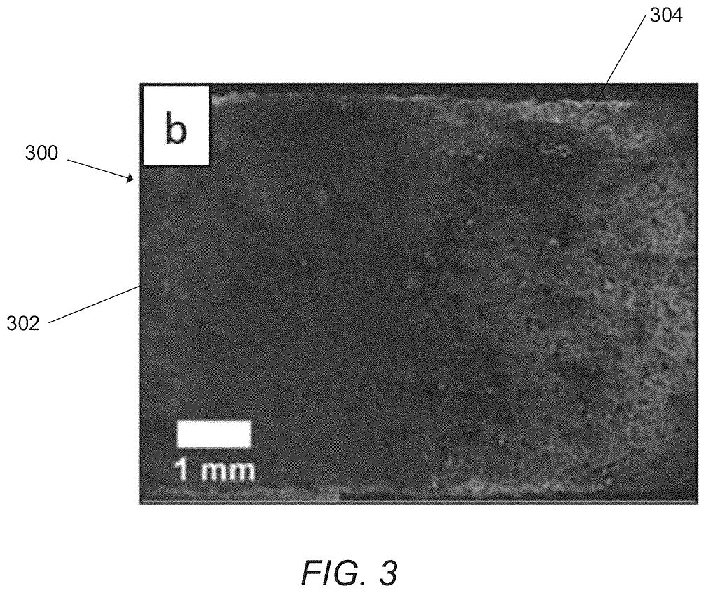

In several embodiments an additively manufactured mold can have regions with fully dense material and regions with high porosity. An example of an additively manufactured object with fully dense regions and high porosity regions is conceptually illustrated in FIG. 3. The object 300 includes a fully dense region 302 and a high porosity region 304.

While specific processes, apparatuses and/or systems for an additively manufactured object with fully dense regions and high porosity regions are described above, any of a variety of processes and/or systems can be utilized as an additively manufactured object with fully dense regions and high porosity regions as appropriate to the requirements of specific applications. In certain embodiments, steps and/or components may be performed and/or configured in any order, sequence, and/or configuration not limited to the order, sequence and/or configuration shown and described. In a number of embodiments, some of the above steps may be executed or performed substantially simultaneously where appropriate or in parallel to reduce latency and processing times. In some embodiments, one or more of the above steps and/or components can be rearranged or omitted. Although the above embodiments of the invention are described in reference an additively manufactured object with fully dense regions and high porosity regions, the techniques disclosed herein may be used in any type of additively manufactured gas venting system and/or other object with porous regions. The techniques disclosed herein may be used within any of the additively manufactured molds, high porosity molds, and/or process therefore as described herein.

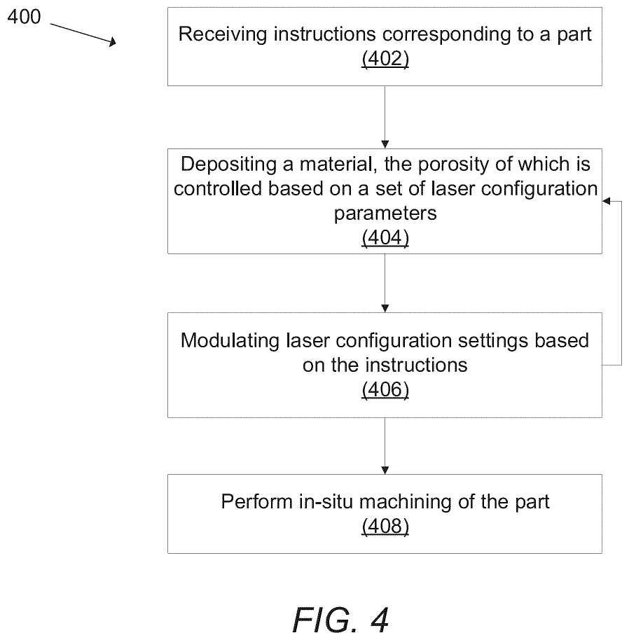

Several embodiments can include processes for generating (e.g., additively manufacturing) molds with varying porosities. An example process for additively manufacturing an object (e.g., a mold) is conceptually illustrated in FIG. 4. A process 400 can receive (402) instructions (e.g., a toolpath). The instructions can be configured for use by an additive manufacturing system (e.g., a laser and/or electron beam powder bed fusion and/or direct energy deposition systems) to generate an object (e.g., a part). In several embodiments, the instructions can include information capable of causing the additive manufacturing system to generate an object with varying local porosity. In particular, the instructions could include configuration parameter laser settings, the modulation of which can control the porosity of deposited material. The process can deposit (404) material, the porosity of which is controlled by modulation of the laser parameters. The process 400 can modulate (406) the set of laser configuration parameters (e.g., a set of configuration parameters corresponding to porosity of deposited material), the new set of laser configuration parameters (e.g., a porosity setting) can be determined based on and/or included in the received instructions. The instructions can correspond to printed object having locally varying porosity. The process 400 can continually loop between applying material and changing laser parameters to control the porosity of the printed structure according to the instructions. In this way the process can proceed until the part is completed. The process 400 can further include performing (408) in-situ machining of the part. In accordance with many embodiments of the invention, porous molds can be configured for use in a manufacturing process. The manufacturing process can be one or more of injection molding, blow molding, extrusion, vacuum casting, vacuum forming, thermoforming, compression molding, rotational molding, hydroforming, and die casting.

While specific processes, apparatuses and/or systems for a process for additively manufacturing an object (e.g., a mold) are described above, any of a variety of processes and/or systems can be utilized as an example process for additively manufacturing an object (e.g., a mold) as appropriate to the requirements of specific applications. In certain embodiments, steps and/or components may be performed and/or configured in any order, sequence, and/or configuration not limited to the order, sequence and/or configuration shown and described. In a number of embodiments, some of the above steps may be executed or performed substantially simultaneously where appropriate or in parallel to reduce latency and processing times. In some embodiments, one or more of the above steps and/or components can be rearranged or omitted. Although the above embodiments of the invention are described in reference an example process for additively manufacturing an object (e.g., a mold), the techniques disclosed herein may be used in any type of additively manufactured gas venting system and/or other object with porous regions. The techniques disclosed herein may be used within any of the additively manufactured molds, high porosity molds, and/or process therefore as described herein.

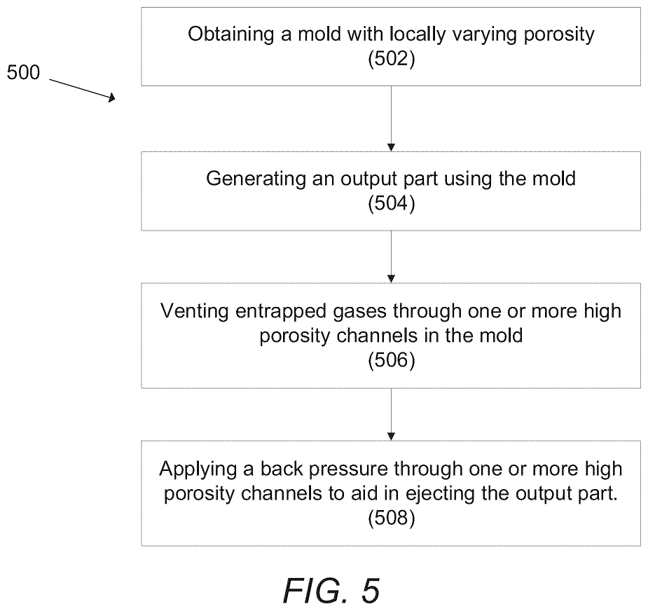

In several embodiments, a process can vent gases through one or more high porosity channels in a mold. This can improve output part quality. Further, the same and/or different porosity channels can be used to apply a back pressure. The back pressure can aid in ejecting the part. An example process for using locally porous molds to manufacture output parts is conceptually illustrated in FIG. 5. A process 500 can include obtaining (502) a mold with a locally varying porosity. The mold can be an additively manufactured mold. The mold can be used to generate (504) an output part. During the generation of the part, the entrapped gases can be vented (506) through at least one high porosity channel. High porosity channels, in various embodiments can be regions of material with a sufficiently high porosity to allow the transmission of gas. Once the output part is ready, the process 500 can apply (508) a back pressure through at least one high porosity channel to provide a force for ejecting the output part from the mold.

While specific processes, apparatuses and/or systems for a process for using locally porous molds to manufacture output parts are described above, any of a variety of processes and/or systems can be utilized as a process for using locally porous molds to manufacture output parts as appropriate to the requirements of specific applications. In certain embodiments, steps and/or components may be performed and/or configured in any order, sequence, and/or configuration not limited to the order, sequence and/or configuration shown and described. In a number of embodiments, some of the above steps may be executed or performed substantially simultaneously where appropriate or in parallel to reduce latency and processing times. In some embodiments, one or more of the above steps and/or components can be rearranged or omitted. Although the above embodiments of the invention are described in reference a process for using locally porous molds to manufacture output parts, the techniques disclosed herein may be used in any type of additively manufactured gas venting system and/or other object with porous regions. The techniques disclosed herein may be used within any of the additively manufactured molds, high porosity molds, and/or process therefore as described herein.

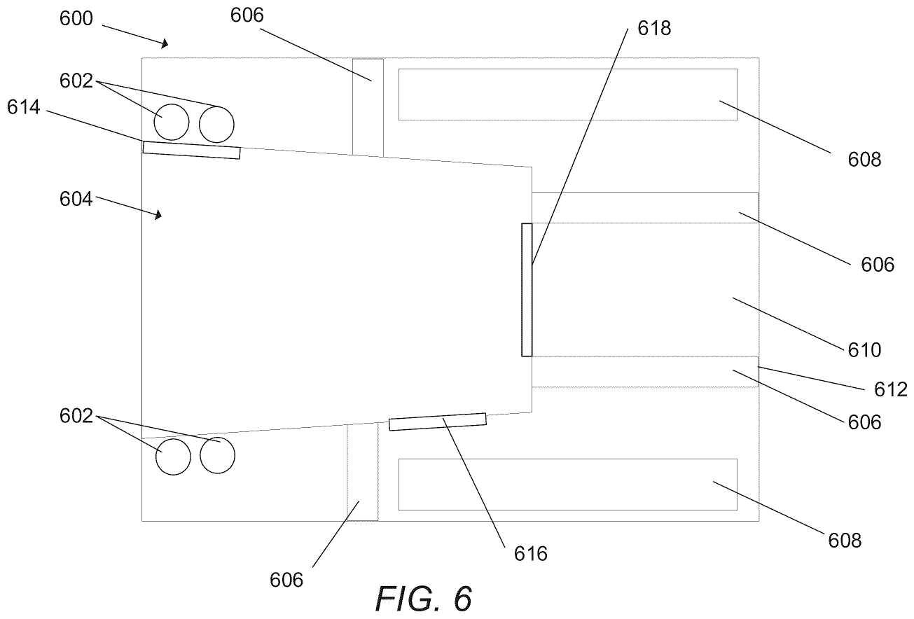

Additive manufacturing, in several embodiments, can be capable of generating molds with conformal thermal controlling elements, high porosity channel structures, and/or light weighting structures. A first example mold with locally varying porosity is conceptually illustrated in FIG. 6. A mold 600 can have conformal thermal controlling elements 602. The conformal thermal controlling elements can be formed by a porosity channel, and/or by a vacant space channel is accordance with embodiments of the invention. The conformal thermal controlling elements can be separated from a mold cavity 604 by a thin wall. The mold cavity 604 can have a set of gas venting porosity channels 606. Porosity channels can be suitable for venting entrapped gases during mold use and/or porosity channels can be used for applying back pressure through for ejecting an output part from the mold. The mold 600 can also include one or more light weighted regions 608. Light weighted regions can be vacant regions, and/or low porosity regions. The mold 600 can further include fully dense regions, such as fully dense region 610. In accordance with embodiments of the invention, porosity channels can have porosities which vary along the geometry of the channel. Porosity can vary step-wise and/or gradually between and/or with portions (e.g., with porosity channels, light-weighted regions, and/or thermal controlling elements). The porosity of the porosity channels can be configured based on an expected gas flow rate to be accommodated by the channel. Each porosity channel 606 can have a channel outlet 612. A first thin porous region 614 can be disposed on the surface of the mold cavity 604. The porous region 614 can be disposed between the thermal controlling elements 602. A second thin porous region 616 can be disposed on the surface of the mold cavity 604. The porous region 616 can be disposed between a region of material that is fully dense and the mold cavity 604. A third thin porous region 618 can be disposed on the surface of the mold cavity 604. The porous region 618 can be disposed on a mold cavity 604 such that venting gases can travel through the porous region 618 and into the porosity channels 606. The porous region can be arranged so as to increase the porous surface area for venting gases through one or more porosity channels. In several embodiments, a mold body defines a mold cavity. Porosity channels can be fluid communication with the mold cavity. Porosity channels can be configured to vent gas from the mold cavity and through an outlet. Porosity channels can be regions of sufficiently high porosity to vent entrapped gases from the mold cavity during the manufacture of an output part. Porosity channels can extend along a length from a mold cavity to a channel outlet. In accordance with embodiment of the invention, porosity channels can have a first porosity in a first portion adjacent to a mold cavity, and a second porosity in a second portion adjacent to a channel outlet. The second porosity can be greater than the first porosity. The second portion can be a vacant space (e.g., 100% porosity).

While specific processes, apparatuses and/or systems for a mold with locally varying porosity are described above, any of a variety of processes and/or systems can be utilized as a mold with locally varying porosity as appropriate to the requirements of specific applications. In certain embodiments, steps and/or components may be performed and/or configured in any order, sequence, and/or configuration not limited to the order, sequence and/or configuration shown and described. In a number of embodiments, some of the above steps may be executed or performed substantially simultaneously where appropriate or in parallel to reduce latency and processing times. In some embodiments, one or more of the above steps and/or components can be rearranged or omitted. Although the above embodiments of the invention are described in reference mold with locally varying porosity, the techniques disclosed herein may be used in any type of additively manufactured gas venting system and/or other object with porous regions. The techniques disclosed herein may be used within any of the additively manufactured molds, high porosity molds, and/or process therefore as described herein.

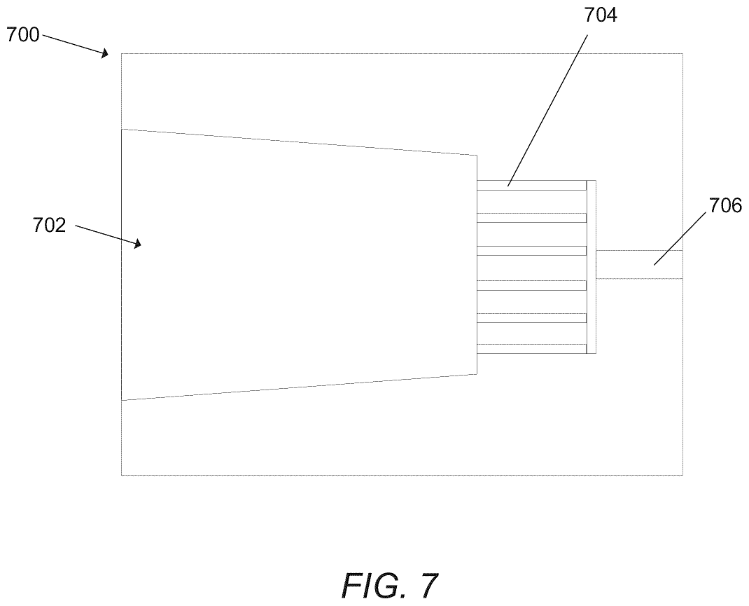

In numerous embodiments, a mold can have high porosity channels in a tree-like arrangement. A second example of a high porosity mold is conceptually illustrated in FIG. 7. Mold 700 includes a cavity 702 connected to porosity channels 704. The porosity channels 704 are arranged in a tree like structure and the porosity channels can be combined into an outlet channel 706. The outlet channel and/or portions of the porosity channel can be formed of high porosity material and/or material voids in accordance with a number of embodiments of the invention.

While specific processes, apparatuses and/or systems for a mold with locally varying porosity are described above, any of a variety of processes and/or systems can be utilized as a mold with locally varying porosity as appropriate to the requirements of specific applications. In certain embodiments, steps and/or components may be performed and/or configured in any order, sequence, and/or configuration not limited to the order, sequence and/or configuration shown and described. In a number of embodiments, some of the above steps may be executed or performed substantially simultaneously where appropriate or in parallel to reduce latency and processing times. In some embodiments, one or more of the above steps and/or components can be rearranged or omitted. Although the above embodiments of the invention are described in reference a mold with varying local porosity, the techniques disclosed herein may be used in any type of additively manufactured gas venting system and/or other object with porous regions. The techniques disclosed herein may be used within any of the additively manufactured molds, high porosity molds, and/or process therefore as described herein.

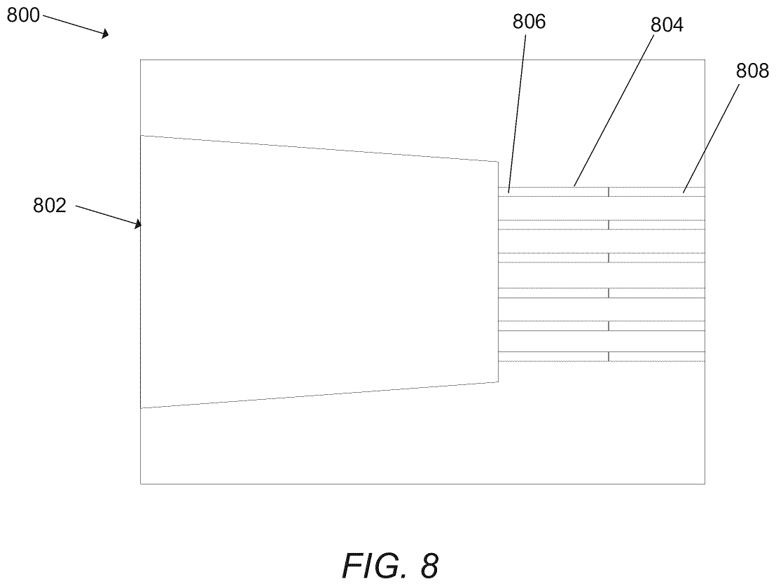

In some embodiments, a mold can have high porosity channels, and each high porosity channel can have a first portion with a first porosity and a second portion with a second porosity. A third example of a high porosity mold is conceptually illustrated in FIG. 8. Mold 800 includes a cavity 802 connected to porosity channels 804. The porosity channels connected to the cavity 802 at a first end of a first portion 806 of the porosity channel 804. The first portion 806 can be connected to a second portion 808 of the porosity channel. The first portion 806 can have a first porosity and the second portion 808 can have a second porosity. The second porosity can be greater than the first porosity in several embodiments.

While specific processes, apparatuses and/or systems for a mold with varying local porosity are described above, any of a variety of processes and/or systems can be utilized as a mold with varying local porosity as appropriate to the requirements of specific applications. In certain embodiments, steps and/or components may be performed and/or configured in any order, sequence, and/or configuration not limited to the order, sequence and/or configuration shown and described. In a number of embodiments, some of the above steps may be executed or performed substantially simultaneously where appropriate or in parallel to reduce latency and processing times. In some embodiments, one or more of the above steps and/or components can be rearranged or omitted. Although the above embodiments of the invention are described in reference a mold with varying local porosity, the techniques disclosed herein may be used in any type of additively manufactured gas venting system and/or other object with porous regions. The techniques disclosed herein may be used within any of the additively manufactured molds, high porosity molds, and/or process therefore as described herein.

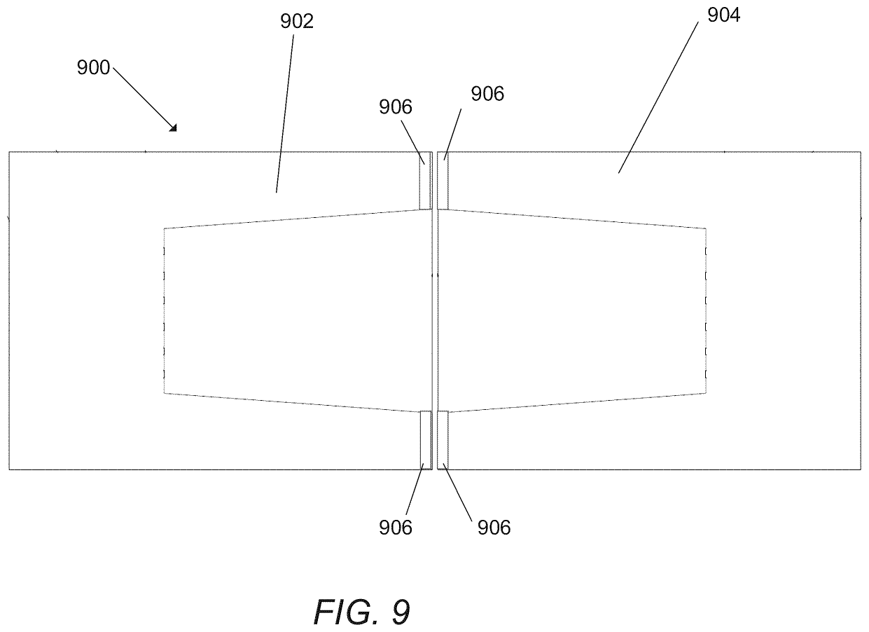

While specific processes, apparatuses and/or systems for a mold with varying local porosity are described above, any of a variety of processes and/or systems can be utilized as a mold with varying local porosity as appropriate to the requirements of specific applications. In certain embodiments, steps and/or components may be performed and/or configured in any order, sequence, and/or configuration not limited to the order, sequence and/or configuration shown and described. In a number of embodiments, some of the above steps may be executed or performed substantially simultaneously where appropriate or in parallel to reduce latency and processing times. In some embodiments, one or more of the above steps and/or components can be rearranged or omitted. Although the above embodiments of the invention are described in reference a mold with varying local porosity, the techniques disclosed herein may be used in any type of additively manufactured gas venting system and/or other object with porous regions. The techniques disclosed herein may be used within any of the additively manufactured molds, high porosity molds, and/or process therefore as described herein. In accordance with various embodiments of the invention, porous regions can be disposed along mold mating surfaces. This can be beneficial for gas venting. An example mold with porous regions along mold mating surfaces is conceptually illustrated in FIG. 9. A mold 900 can have a first mold body 902 and a second mold body 904. The first mold body 902 and the second mold body 904 can each have porous regions 906 positioned along the interface regions of the mold bodies.

While specific processes, apparatuses and/or systems for a mold with porous regions along mold mating surfaces are described above, any of a variety of processes and/or systems can be utilized as a mold with porous regions along mold mating surfaces as appropriate to the requirements of specific applications. In certain embodiments, steps and/or components may be performed and/or configured in any order, sequence, and/or configuration not limited to the order, sequence and/or configuration shown and described. In a number of embodiments, some of the above steps may be executed or performed substantially simultaneously where appropriate or in parallel to reduce latency and processing times. In some embodiments, one or more of the above steps and/or components can be rearranged or omitted. Although the above embodiments of the invention are described in reference a mold with porous regions along mold mating surfaces, the techniques disclosed herein may be used in any type of additively manufactured gas venting system and/or other object with porous regions. The techniques disclosed herein may be used within any of the additively manufactured molds, high porosity molds, and/or process therefore as described herein.

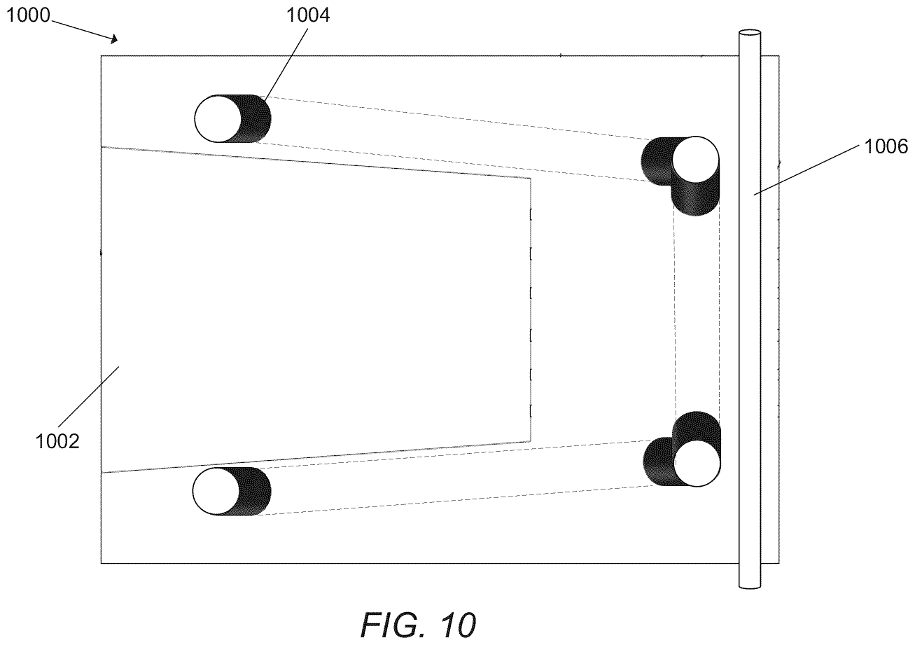

In several embodiments, additively manufactured molds can have internal thermal control channels and externally connected thermal control channels. Externally connected thermal control channels can be control channels that are in fluid communication with a fluid source outside the mold. Internal control channels can be those control channels which are not in fluid communication with fluid external to the mold. An example mold with internal thermal control channels and externally connected thermal control channels is conceptually illustrated in FIG. 10. The mold 1000 can have a mold cavity 1002. One or more internal thermal control channels 1004 can be arranged around the mold cavity 1002. The internal thermal control channels 1004 can be conformal to the cavity 1002. The mold 1000 can also include a an externally connected thermal control channel 1006. The externally connected thermal control channel can be in fluid communication with a source of fluid located external to the mold 1000. Externally connected thermal control channels can pumped fluid loops, second heat pipe systems, loop heat pipes, and other systems.

While specific processes, apparatuses and/or systems for a mold with internal thermal control channels and externally connected thermal control channels are described above, any of a variety of processes and/or systems can be utilized as a mold with internal thermal control channels and externally connected thermal control channels as appropriate to the requirements of specific applications. In certain embodiments, steps and/or components may be performed and/or configured in any order, sequence, and/or configuration not limited to the order, sequence and/or configuration shown and described. In a number of embodiments, some of the above steps may be executed or performed substantially simultaneously where appropriate or in parallel to reduce latency and processing times. In some embodiments, one or more of the above steps and/or components can be rearranged or omitted. Although the above embodiments of the invention are described in reference a mold with internal thermal control channels and externally connected thermal control channels, the techniques disclosed herein may be used in any type of additively manufactured gas venting system and/or other object with porous regions. The techniques disclosed herein may be used within any of the additively manufactured molds, high porosity molds, and/or process therefore as described herein.

While the above description contains many specific embodiments of the invention, these should not be construed as limitations on the scope of the invention, but rather as an example of one embodiment thereof. Accordingly, the scope of the invention should be determined not by the embodiments illustrated, but by the appended claims and their equivalents.

What is claimed is:

1. An additively manufactured mold, the additively manufactured mold comprising:
a mold body defining a mold cavity; and
at least one porosity channel in fluid communication with the mold cavity;
wherein the at least one porosity channel has a sufficiently high porosity to vent entrapped gases from the mold cavity during the manufacture of an output part.

2. The additively manufactured mold of claim 1, wherein the at least one porosity channel extends from the mold cavity to a channel outlet.

3. The additively manufactured mold of claim 1, wherein the mold body and the at least one porosity channel form a single additively manufactured part.

4. The additively manufactured mold of claim 1, wherein the at least one porosity channel is a region of material with a sufficiently high porosity along a length to vent entrapped gases from the mold cavity to a channel outlet.

5. The additively manufactured mold of claim 1, wherein the at least one porosity channel has a first porosity and the mold body has a region with a second porosity, the first porosity different from the second porosity.

6. The additively manufactured mold of claim 1, wherein the at least one porosity channel has a first porosity in a first portion adjacent to the mold cavity, and a second porosity in a second portion adjacent to a channel outlet, and wherein the second porosity is greater than the first porosity.

7. The additively manufactured mold of claim 1, wherein the at least one porosity channel comprises a first porosity channel and a second porosity channel, and wherein the first and second porosity channel meet of form a third porosity channel such that the third porosity channel is in fluid communication with the first porosity channel, the second porosity channel, and an outlet.

8. The additively manufactured mold of claim 1, wherein the additively manufactured mold is made of a material selected from a list consisting of aluminum alloys, steels, Inconel alloys, other super alloys, titanium alloys, and refractory alloys.

9. A process for additively manufacturing a mold, the process comprising:
receiving instructions for a mold, the mold comprising:
a mold body defining a mold cavity; and
at least one porosity channel in fluid communication with the mold cavity;
wherein the at least one porosity channel has a sufficiently high porosity to vent entrapped gases from the mold cavity during the manufacture of an output part;
depositing material based on the instructions; and
modulating a set of energy input device configuration parameters based on the instructions such that the porosity of the mold varies locally according to the instructions.

10. The process of additively manufacturing a mold of claim 9, wherein the instructions are configured to be used by a powder bed fusion system to control a set of machine parameters during an additive manufacturing process performed to generate the mold.

11. The process of additively manufacturing a mold of claim 9, the process further comprising manufacturing the mold.

12. The process of additively manufacturing a mold of claim 9, wherein the set of laser configuration parameters are selected from a list, the list consisting of laser input power, scan speed, hatch spacing, layer thickness, hatch geometry, spot size, laser spot geometry, bed temperature, and beam offset.

13. The process of additively manufacturing a mold of claim 9, wherein the material is deposited using a powder bed fusion system.

14. The process of additively manufacturing a mold of claim 9, wherein the mold body comprises at least one thermal controlling element disposed within the mold body.

15. The process of additively manufacturing a mold of claim 9, wherein a thermal controlling element is a thermal controlling element selected from a list, the list consisting of pumped fluid loops, integrated heat pipes, vapor chambers, and oscillating heat pipes.

16. The process of additively manufacturing a mold of claim 9, wherein a thin layer of high porosity material can be disposed between the cavity and a thermal controlling element.

17. The process of additively manufacturing a mold of claim 9, wherein a thermal control element comprises internal conformal channels that conform to the mold cavity.

18. The process of additively manufacturing a mold of claim 9, wherein the energy input device is selected from a list consisting of a laser and an electron beam device.

19. A process for manufacturing an output part with an additively manufactured mold, the process comprising:
obtaining a mold, the mold comprising:
a mold body defining a mold cavity; and
at least one porosity channels in fluid communication with the mold cavity;
wherein the at least one porosity channels have a sufficiently high porosity to vent entrapped gases from the mold cavity during the manufacture of an output part;
generating an output part using the mold;
venting entrapped gasses through a first porosity channel of the at least one porosity channels; and
applying a back pressure onto the output part through a second porosity channel of the at least one porosity channels.

20. The process for manufacturing an output part with an additively manufacturing a mold of claim 19, wherein the back pressure ejects the output part.
